(19) United States
(12) Patent Application Publication
(10) Pub. No.: US 2008/0101368 A1
(43) Pub. Date: May 1, 2008

(54) METHOD AND APPARATUS FOR PROVIDING MESSAGE CONTENT BASED ROUTE SELECTION

(76) Inventor: Joseph B. Weinman, Basking Ridge, NJ (US)

Correspondence Address: Mr. John Etchells;AT&T Enterprise Services, Inc., Room 2A-207, One AT&T Way, Bedminster, NJ, 07921, US

(21) Appl. No.: 11/555,195

(22) Filed: Oct. 31, 2006

(51) Int. Cl. H04L 12/56

(52) U.S. Cl. 370/392; 370/401

(57) ABSTRACT

A method and apparatus for selecting routes based on message content for packets transmitted over networks such as packet networks are disclosed. The method receives one or more packets and determines message content associated with said packets. The method then selects a route for transmission of said one or more packets based on said message content.

The present invention relates generally to communication networks and, more particularly, to a method and apparatus for selecting routes based on message content for packets transmitted over networks such as packet networks, e.g., Internet Protocol (IP), Voice over Internet Protocol (VoIP), Service over Internet Protocol (SoIP), and Label Switched Path networks.

### BACKGROUND OF THE INVENTION

Internet Protocol transport networks and services such as VoIP and SoIP are becoming ubiquitous and businesses and consumers are relying on their Internet Protocol connections to obtain all their communications services. The routing of packets towards their destination through a private enterprise network or a network service provider's network is facilitated via routers. Routers typically have access to more than one possible path for packet forwarding towards a destination. That is, the router chooses a next hop for each packet prior to transmission. In order to choose the best path, routers and ancillary equipment such as route reflectors are used to build and maintain routing tables with information that may be used for route selection, e.g., routers associate a next-hop based on each destination IP address, etc. The content of the routing table may be built based on algorithms that compare path length, cost of path, congestion, failure rates, etc. The route selection is then made based on the destination address of the packet and the content of the routing table. However, the customer applications may impose a variety of requirements on an internal enterprise or service provider network. For example, a customer may have different routing requirements based on message content. In one example, the customer may have message content that is delay sensitive. In another example, the customer may need packets with a specific type of message content (type of payload) to take the same route to limit variation in jitter, i.e., variable delay.

Therefore, there is a need for a method that enables an enterprise or service provider to provide message-content-based route selection.

### SUMMARY OF THE INVENTION

In one embodiment, the present invention discloses a method and apparatus for providing message-content-based route selection on networks such as packet networks. The method receives one or more packets and determines a message content associated with said packets. The method then selects a route for transmission of the one or more packets based on the message content.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with the current invention for providing message content based route selection;

FIG. 3 illustrates a flowchart of a method for providing message content based route selection; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing message content based route selection on networks such as packet networks, e.g., IP networks, MPLS networks, Voice over Internet Protocol (VoIP) and Service over Internet Protocol (SoIP) networks. Although the present invention is discussed below in the context of VoIP and SoIP networks, the present invention is not so limited. Namely, the present invention can be applied for other networks such as cellular networks and the like.

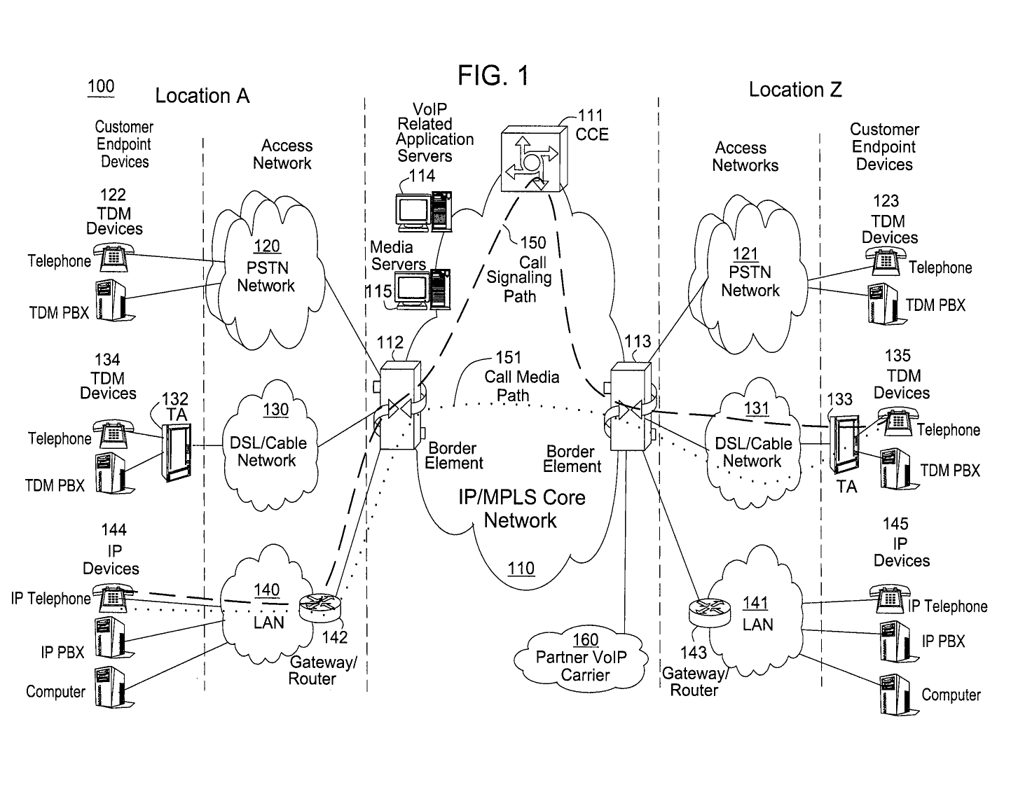

To better understand the present invention, FIG. 1 illustrates an exemplary network 100, e.g., a packet network such as a converged voice, data, and video network related to the present invention. Exemplary packet networks include Internet protocol (IP) networks, MPLS networks, Asynchronous Transfer Mode (ATM) networks, frame-relay networks, and the like. An IP network is broadly defined as a network that uses Internet Protocol to exchange data packets. Thus, a Voice over Internet Protocol (VoIP) network or a Service over Internet Protocol (SoIP) network is considered an IP network.

In one embodiment, the converged network may comprise various types of customer endpoint devices connected via various types of access networks to a carrier (a service provider) core infrastructure over an Internet Protocol/Multi-Protocol Label Switching (IP/MPLS) based core backbone network. Broadly defined, a converged network is a network that is capable of carrying voice signals, video signals, and data, such as email or files as packetized data over an IP network. The present invention is described below in the context of an illustrative converged network. Thus, the present invention should not be interpreted as limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access services by using a Local Area Network (LAN) 140 and 141 with a VoIP gateway or router 142 and 143, respectively. Other IP-based customer devices may include computers, servers, laptops, mobile devices with IP connectivity, network attached storage devices, Storage Area Networks (SANs), content addressed storage devices, SAN fabric switches, and the like.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and/or router 142. A packet based access network 130 or 131, such as DSL or Cable, when used together with a TA 132 or 133, is used to support TDM based customer endpoint devices.

The core converged network infrastructure may comprise several key components, such as the Border Elements (BEs) 112 and 113, the Call Control Element (CCE) 111, data, VoIP and/or video over IP related Application Servers (AS) 114, and Media Server (MS) 115. The BE resides at the edge of the converged network core infrastructure and interfaces with customers' endpoints over various types of access networks. A BE may be typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP, video or data service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on. For calls that originate or terminate in a different carrier, they can be handled through the PSTN 120 and 121 or the Partner IP Carrier 160 interconnections. A customer in location A using any endpoint device type with its associated access network type can communicate with another customer in location Z using any endpoint device type with its associated network type.

The above converged network is described to provide an illustrative environment in which data and voice packets are transmitted on communication networks. The packets are forwarded towards their destination through the enterprise network or network service provider's network via routers. For simplicity, we will sometimes use the term service provider's network to include all variations of a commercial service provider, such as a common carrier, an internal service provider (e.g., the IT/Telecom department), a third party wholesaler, and combinations therein. When a router has access to more than one possible path for forwarding a packet, the router chooses the best path for the packet prior to transmission. In order to choose the best path, each router builds and maintains a routing table with information that may be used for route selection, e.g., the router associates a next-hop for each known destination IP address, subnet, or network, etc. The routing table is built based on an algorithm that compares path length, cost of path, failure rates, etc. The route selection is then made based on the destination address of the packet and the routing table as built based on the algorithm. However, as more and more applications are being supported by the IP network, more and more customer requirements are imposed on the enterprise network or service provider's network. For example, a customer may have different routing requirements based on the message content. Message content refers to the information that is stored in the payload portion of a packet. For example, a packet may contain sensitive or private (secured) information, etc. In another example, the customer may have a message content that is delay sensitive. For example financial market data or equity purchase or sale transactions may need to be transmitted on a path with minimal delay. Important corporate broadcast video data may need to be transmitted on a path with lowest packet loss. In another example, the customer may need packets with a specific type of message content (based on application layer) to take the same route. For example, a bank may request transactions above a specific threshold to use a path with network level (layer 1) protection.

Current methods only enable destination selection but not route selection. For the above example of bank transactions above a specific threshold, a bank may direct transactions that exceed the threshold (e.g., transactions greater than $10,000) towards a specific destination. Thus, although there is a requirement as to the destination, there is no requirement as to which route the packets must traverse to arrive at the specified destination. That is, the destination of the packet is determined based on the message content but the packet may take any route. Therefore, there is a need for a method that enables the enterprise network or service provider network to provide message content based route selection.

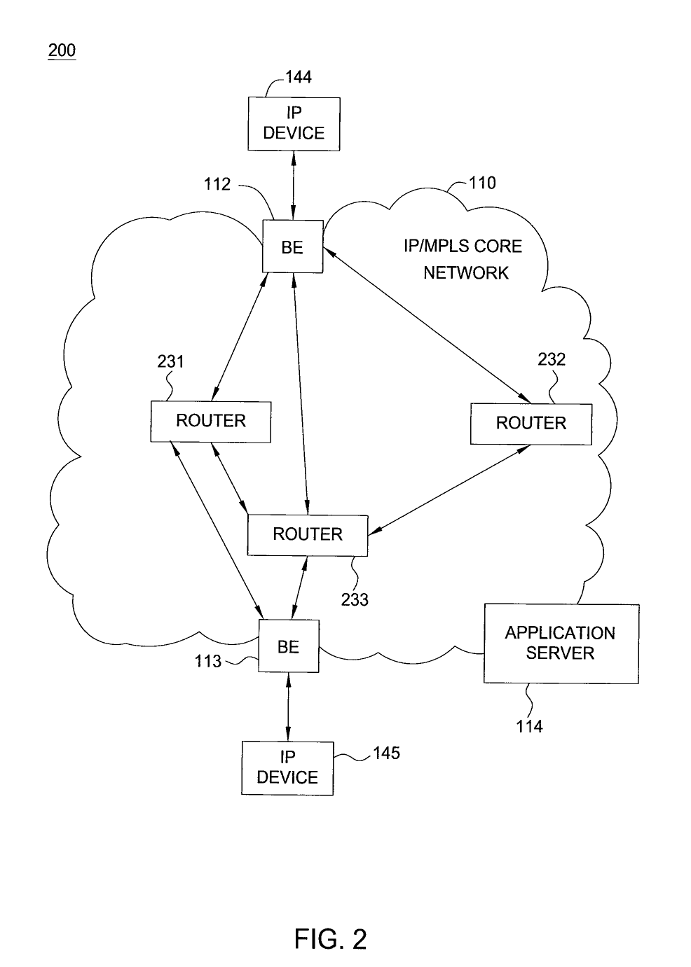

In one embodiment, the present invention provides a method and apparatus for providing message content based route selection on networks such as packet networks. FIG. 2 illustrates an exemplary network 200 with one embodiment of the current invention for message-content-based route selection. For example, a customer is using IP device 144 to access IP services such as VoIP and SoIP services. IP device 144 is connected to a Border Element (BE) 112 located on a core network, e.g., an IP/MPLS core network 110. It should be appreciated that the Border Element may in fact be a Provider Edge router, or an enterprise router connected to the IP device. The routers 231, 232 and 233 are part of the IP/MPLS core network 110 and are used to route packets to IP device 145. As such, the packets traverse the core network from BE 112 to BE 113 via one or more routers in the core network 110. For example, the packets may traverse from BE 112 to router 231 then to BE 113, or BE 112 to router 231 to router 233 and then to BE 113, or BE 112 to router 233 and then to BE 113, and so on. The packets are then sent to the IP device 145 connected to the border element 113. Note that each router maintains a routing table for forwarding packets towards their destination. In one embodiment, the IP/MPLS core network may deploy an application server 114, which may directly and/or indirectly interact with customers and implements message content based route selection. As an example of direct interaction, customers may specify, through a portal (not shown) to the application server, rules such as that messages matching a particular pattern or rule shall be sent according to a particular route, those matching a different pattern or rule shall be sent according to a different route. As an example of indirect interaction, customer data traversing the network among routers 231, 232, and 233 may include control packets specifying such rules. Note that only the network elements used to describe the invention are illustrated in FIG. 2.

In one embodiment, the service provider enables one or more routers to determine the message content associated with one or more packets. For example, a router may examine the payload of one or more packets to identify the message content. Note that identification of the message content may be based on examination of one or more packets. That is, a message may need to be examined for several frames (packets) prior to proper identification of message content, or alternatively may be based on examination of one packet. The service provider also enables the routers to select a route based on said message content. For example, message content may identify application layer information, characteristics, etc. of one or more packets. The route selection may be based on specifying applications, characteristics, etc. or may be based on analysis to determine delay sensitivity levels of packets, packets that should be sent on the same route, etc. For example, a route selection may be based on identifying packets associated with image applications, File Transfer Protocol (FTP), etc. A bank may request a specific route to be used for packets containing customer information of a personal nature, e.g., customer names, Personal Identification Numbers (PINs), etc. In an alternative embodiment, the application server 114 or border element 112 may transcode message content, e.g., from voice to text, and make a further route determination thereby. For example, should the word “purchase” be used in a conversation with a call center agent, the call flow message stream may be alternatively routed.

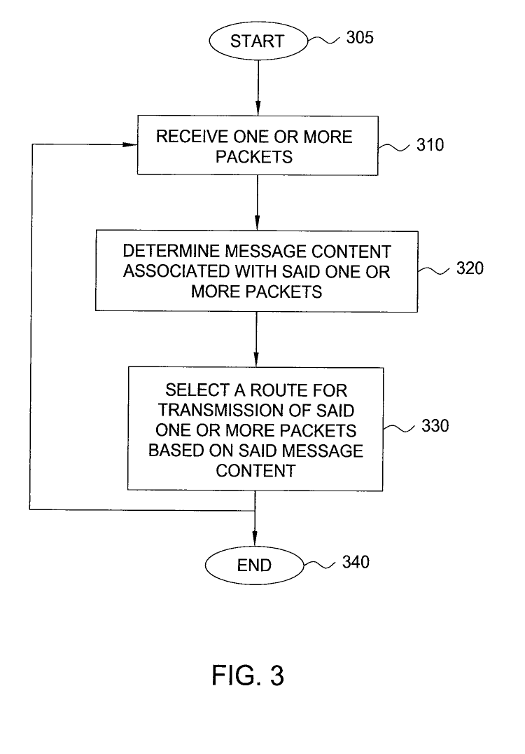

FIG. 3 illustrates a flowchart of a method 300 for providing message content-based route selection. On one embodiment, the service provider enables routers to determine message content. For example, a bank transaction may be examined, to determine whether or not the payload in the packet corresponds to a transaction that exceeds a specific threshold (e.g., to determine whether a predefined dollar amount is exceeded, to determine whether or not the packet contains proprietary information, e.g., customer PIN, etc.). In another example, a financial institution may request packets associated with stock market transactions to be identified and then forwarded on a specific route. One reason can be that an enterprise customer may want packets associated with stock market transactions to use a route with the least delay. For example, in some cases a quoted stock price may change if the route has significant delay. Thus, the service provider can provide a service to its customers that enables routers to select a route based on message content. In another example, an investment firm may cover a small subset of traded equity firms, but be interested in all the market data to determine trends. Market data transaction messages for the subset may be sent via a first route, and market data messages outside that subset may be sent via a second route.

Method 300 starts in step 305 and proceeds to step 310. In step 310, method 300 receives one or more packets. For example, a border element receives one or more packets from a customer for forwarding through the IP/MPLS core network. In another example, a router (e.g., broadly a service provider device) in the IP/MPLS core network receives one or more packets from a border element or another router for forwarding towards a destination.

In step 320, method 300 determines a message content associated with said one or more packets. For example, a bank may have requested packets containing payload for transactions above a specific threshold to be identified and treated differently, e.g., routed through a specific route. Once the message content is extracted from one or more packets, the method then determines the message content based on specified criteria (e.g., as specified by a customer, by a governmental agency, by the service provider, and so on).

In step 330, method 300 selects a route for transmission of said one or more packets based on said message content. For example, if the message content of packets is deduced as containing a transaction above $10,000, then the route that is selected for the packets is specified for this type of transactions. In one embodiment, the route selection is implemented using a rule based engine to specify rules for selection of a route.

In one embodiment, the selection of a route is implemented by selecting a pre-provisioned route across an IP/MPLS network. For example, a plurality of label switched paths may be pre-provisioned for a customer and a packet is forwarded on one of the pre-provisioned paths based on message content. Method 300 then proceeds to step 340 to end processing the current packets or to step 310 to continue receiving more packets. In another embodiment, virtual label switched paths maybe created in an IP router based network by installing specific routing tables into the routers that specify forwarding based on source IP, destination IP, and port number.

In one embodiment, the message content is carried in the payload portion of the packet. In an alternate embodiment, the payload portion of a packet is analyzed to identify the message content and then the identified message content is provided in the overhead portion of a packet to enable downstream devices to retrieve and utilize the information. For example, if a border element determines the message content, it may provide the information to routers in the IP/MPLS core network by setting one or bits in the packet overhead that is representative of the message content. In other words, since the BE may have expended a substantial amount of computational cycles in deducing the message content from the payload, it can provide the message content in a truncated form that can be readily understood by the next network component without having to process the payload again (e.g., a code that is representative of a type of message content). This truncated form can be a code that is embedded in the header or in the payload of the packet. The downstream routers may then utilize the information to avoid some processing steps.

In one embodiment, the service provider provides a service with message content based routing. For example, a service that separates packets that are routed based on message content may be defined. The source device (e.g., the customer device originating the packets) may provide an indication in the header of a packet. When the packet reaches the service provider's network (e.g., reaches the BE), the header may be read to determine whether or not the packet is to be routed in accordance with a service where packets are routed based on message content. If the message content based routing service is not needed, then the packet may be forwarded using the normal process. Otherwise, the message content may be examined and then a route may be selected accordingly.

In one embodiment, the service provider enables customers to specify how message content is to be determined, e.g., via application server 114. For example, a bank may specify packets to be examined based on application layer information, etc. In another example, a customer may wish packets associated with voice to be identified and routed on a particular route, e.g., a very confidential phone call.

In one embodiment, the service provider enables customers to specify rules for selecting a route for transmission of packets. For example, a customer may specify packets for voice traffic to be transmitted on routes with no satellite based transmission systems in order to avoid delay. The customer's packets are then examined to determine the message content and packets with voice payload are forwarded on routes with no satellite based transmission. That is, routes with layer 1 transmission on optical fiber networks, co-axial cable networks, etc. are used for such voice packets. In another example, a label switched path may be used for voice and other delay sensitive packets while other packets are sent on routes determined based on the Open Shortest Path First (OSPF) protocol.

In one embodiment, the service provider records usage of message content based transmission service, e.g., via application server 114. For example, the billing of said message content based routing service may be based on usage, i.e., how packets were routed based on content message.

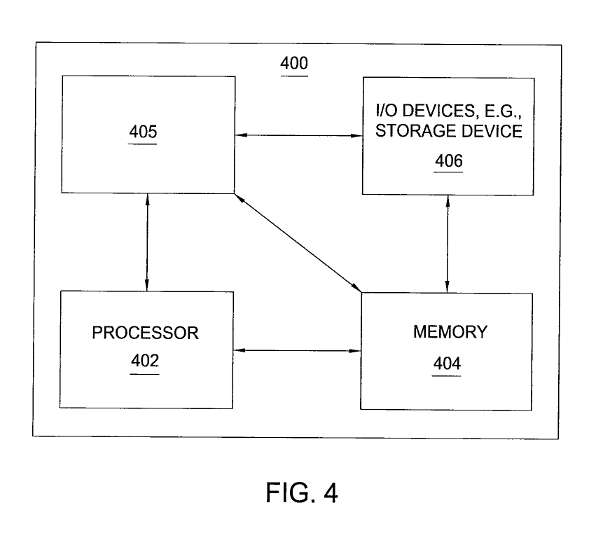

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing message content based route selection, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing message content based route selection can be loaded into memory 404 and executed by processor 402 to implement the functions as discussed above. As such, the present method 405 for providing message content based route selection (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for routing packets in a communication network, comprising:
receiving one or more packets;
determining a message content associated with said one or more packets; and
selecting a route for transmission of said one or more packets based on said message content.

2. The method of claim 1, wherein said selecting said route for transmission is implemented using a rule based engine.

3. The method of claim 1, wherein said selecting said route for transmission selects a pre-provisioned route among a plurality of pre-provisioned routes.

4. The method of claim 1, wherein said determining said message content is accomplished at an application layer.

5. The method of claim 1, wherein said determining said message content analyzes a payload portion of each of said one or more packets.

6. The method of claim 1, wherein said method for routing packets is provided as a service by a service provider of said communication network.

7. The method of claim 6, wherein said service enables a customer to specify one or more criteria for routing said one or more packets based on message content.

8. The method of claim 1, further comprising:
inserting at least one code that is representative of said message content into a header or a payload of said one or more packets.

9. A computer-readable medium having stored thereon a plurality of instructions, the plurality of instructions including instructions which, when executed by a processor, cause the processor to perform the steps of a method for routing packets in a communication network, comprising:
receiving one or more packets;
determining a message content associated with said one or more packets; and
selecting a route for transmission of said one or more packets based on said message content.

10. The computer-readable medium of claim 9, wherein said selecting said route for transmission is implemented using a rule based engine.

11. The computer-readable medium of claim 9, wherein said selecting said route for transmission selects a pre-provisioned route among a plurality of pre-provisioned routes.

12. The computer-readable medium of claim 9, wherein said determining said message content is accomplished at an application layer.

13. The computer-readable medium of claim 9, wherein said determining said message content analyzes a payload portion of each of said one or more packets.

14. The computer-readable medium of claim 9, wherein said method for routing packets is provided as a service by a service provider of said communication network.

15. The computer-readable medium of claim 14, wherein said service enables a customer to specify one or more criteria for routing said one or more packets based on message content.

16. The computer-readable medium of claim 9, further comprising:
inserting at least one code that is representative of said message content into a header or a payload of said one or more packets.

17. An apparatus for routing packets in a communication network, comprising:
means for receiving one or more packets;
means for determining a message content associated with said one or more packets; and
means for selecting a route for transmission of said one or more packets based on said message content.

18. The apparatus of claim 17, wherein said means for selecting said route for transmission selects a pre-provisioned route among a plurality of pre-provisioned routes.

19. The apparatus of claim 17, wherein said means for determining said message content analyzes a payload portion of each of said one or more packets.

20. The apparatus of claim 17, further comprising:
means for inserting at least one code that is representative of said message content into a header or a payload of said one or more packets.
